(19) United States
(12) Patent Application Publication
(10) Pub. No.: US 2018/0260786 A1
(43) Pub. Date: Sep. 13, 2018

(54) COGNITIVE SCHEDULER

(71) Applicant: INTERNATIONAL BUSINESS MACHINES CORPORATION, ARMONK, NY (US)

(72) Inventors: Hernan A. Cunico, Holly Springs, NC (US); Asima Silva, Holden, MA (US)

(21) Appl. No.: 15/453,276

(22) Filed: Mar. 8, 2017

(51) Int. Cl. G06Q 10/10; G06N 5/04

(52) U.S. Cl. CPC G06Q 10/1095; G06N 5/043

(57) ABSTRACT

A method, computer system, and a computer program product for cognitive scheduling is provided. The present invention may include receiving an input. The present invention may also include performing a semantic analysis based on the received input. The present invention may then include performing further analysis based on the performed semantic analysis. The present invention may further include performing a predictive analysis based on the performed semantic analysis and the performed further analysis. The present invention may also include providing a notification to a user based on the performed predictive analysis.

### BACKGROUND

The present invention relates generally to the field of computing, and more particularly to cognitive scheduling.

Scheduling events may require entries to be manually typed into a calendar. A notification may be used to remind the user of an approaching event. Manually entering events and organizing entries may consume more time than the user may want to give for a particular event. Seeking a balance between work activities and life events may need a solution that is more than a static entry into a calendar. Many people have a dynamic and busy life to organize, therefore a dynamic approach using a cognitive system may be beneficial.

### SUMMARY

Embodiments of the present invention disclose a method, computer system, and a computer program product for cognitive scheduling. The present invention may include receiving an input. The present invention may also include performing a semantic analysis based on the received input. The present invention may then include performing further analysis based on the performed semantic analysis. The present invention may further include performing a predictive analysis based on the performed semantic analysis and the performed further analysis. The present invention may also include providing a notification to a user based on the performed predictive analysis.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for cognitive scheduling according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for cognitive scheduling. As such, the present embodiment has the capacity to improve the technical field of cognitive scheduling by creating a dynamic approach to organizing and amending events. More specifically, the cognitive scheduler program may adjust a user's calendar to account for activities that may create more productivity. A more productive day may include analyzing a user's sentiment, behaviors and relationships to predict events that may assist a user such as alerting the user to take a break and walk around. Other notifications may alert the user to eat lunch in between meetings or to get a cup of coffee. The cognitive scheduler program also may dynamically adjust schedules based on the user's habits, such as if a meeting consistently runs over the allotted time, then the cognitive scheduler program may alert the user to schedule the next event thirty minutes after the previous meeting instead of a usual shorter time period.

As previously described, scheduling events may require entries to be manually typed into a calendar. A notification may be used to remind the user of an approaching event. Manually entering events and organizing entries may consume more time than the user may want to give for a particular event. Seeking balance between work activities and life events may need a solution that is more than a static entry into a calendar. Many people have a dynamic and busy life to organize, therefore a dynamic approach using a cognitive system may be beneficial.

A cognitive system may complement and support an active lifestyle when balancing both work and personal activities. Life can become busy and people may sometimes forget to postpone smaller events in a demanding schedule. During a work day, a notification to remind a user to eat lunch, take a short re-energizing walk, or get a cup of coffee may be beneficial to the productivity of the user. Some situations and planned activities may take longer than anticipated where the extended time at one event may have a domino effect on all other scheduled activities for that day. If certain events become regularly extended, the effect may be even greater and may place more strain on a person's day. Therefore, it may be advantageous to, among other things, provide a cognitive system that may predict behavior patterns of a user's schedule by understanding the user's routine customs and habits, how the routine customs and habits are affected by the user's schedule and suggest modifications or modify the user's schedule.

According to at least one embodiment, a cognitive approach to balancing a schedule to creating a more productive lifestyle may save time and assist in organizing a user's life over a static approach. A static approach may require manual entry for each new event. An alarm, for example, may require the user to input an event on a particular application and the same application may be used to alert a user before an event may occur. For a user with a busy and dynamic lifestyle, a static alarm, calendar or event management application may require the user to set-up many recurring alarms configured to alert the user at predetermined times and dates. The user may then manually disable alarms the user no longer wants.

A cognitive approach may analyze a user's habits, customs and behaviors, both routine and non-routine, in order to set or adjust the alerts or notifications and to alter the user's existing schedule accordingly. A cognitive scheduler program may add, remove or alter events on a user's existing schedule. The cognitive scheduler program may know the user's behavioral patterns, lifestyle, work schedule and daily schedule. Behavioral knowledge may assist the cognitive scheduler program to determine when may be the best time to alert or notify the user of a routine. The cognitive scheduler program may also effectively integrate unscheduled events into the user's schedule by notifying the user that an event may be added. The cognitive scheduler program may notify the user based on the added event and may ask the user to accept or deny the change in the user's schedule.

The cognitive scheduler program may use a combination of analysis modules such as semantic analysis, behavioral analysis, relationship analysis and predictive analysis to predict productive scheduling events. Semantic analysis associated with scheduled activities used in conjunction with predictive analysis may infer the complexity of interactions associated with the scheduled activities. Semantic analysis may consider a user's currently scheduled activities, historical activities, communications, other individuals involved in the activities, topics discussed and frequency of the activities and discussion topics. Behavior analysis may consider behavior, biometric patterns and sentiment of the user and the behavior, biometric patterns and sentiment of other individuals associated with an event. Behavior analysis may also consider user routines, scheduled activities and unscheduled activities in the context of the user's emotional state. Behavioral patterns in the context of the user's activities and the precursory activities (i.e., activities right before a scheduled activity) may be analyzed in order to optimize the cognitive scheduler program's recommendations to the user. Activities may be new or already defined (i.e., scheduled). For example, if a new activity is added to a user's schedule, then the alert associated with an already scheduled event may change from 15 minutes to 30 minutes with a meaningful message such as “30 minutes until meeting, break now for lunch.”

Relationship analysis may consider the relationship between the user and the other individuals involved in the activities. The predictive analysis module may collect, in a database, and analyze the user's historical and current activities. Other individuals involved in an event may also be analyzed in the predictive analysis module. The predictive analysis module may also collect data that pertains to the other individuals listed on an event and predict a solution that may benefit all people involved. The notification module may be responsible for communicating to the user and updating the user's schedule as needed based on the input provided by the predictive analysis module. The notification may be presented on a user device via a sound alert, text message, verbal message or a device vibration. A user device may consist of a computer, a cellular phone, a tablet, a watch or a vehicle.

The cognitive scheduler program may offer capabilities beyond merely modifying a schedule to accommodate a user's needs by analyzing the user's interactions with scheduled events (i.e., learned events). The user's sentiment and emotions may be used to understand what the user may need. The cognitive scheduler program may rely on existing technology to perform sentiment analysis to determine the emotional state of the user and how the user's emotional state may affect the current tasks. Precursory activities may also consistently trigger certain sentiment or emotional responses which may be saved into a database for the cognitive scheduler program's ability to use at a later time or for the predictive analysis phase. Sentiment of the user may also be analyzed in conjunction with owners (i.e., chairs) of an event. The relationship analysis may create a mutually beneficial solution between the user and the event owner in a situation where the current schedule may conflict.

The cognitive scheduler program may provide specific inputs (i.e., notify the user of adding, deleting or altering the user's schedule) to the user based on the program's understanding of the user sentiment and the user's schedule. The cognitive scheduler program may offer a predictive analysis by analyzing more than a user's history, such as analysis of user interactions, relationships, task dependencies and emotional analysis. In addition to analyzing behavioral patterns, the cognitive scheduler program may analyze tasks and sub-tasks involved and the dependencies associated with a specific activity. Then a potential ripple effect of each task and sub-task may be analyzed to determine how altering one task or sub-task may or may not affect the rest of the scheduled activities, which may or may not affect the user's schedule.

The cognitive scheduler program may use semantic analysis, behavioral analysis and relationship analysis in any order. The cognitive scheduler program may also use one or more of the semantic analysis module, behavioral analysis module and relationship analysis module to predict and possibly add, delete or alter a user's schedule. Each module (e.g., semantic analysis module, behavioral analysis module and relationship analysis module) may work independently, interdependently or dynamically with one another.

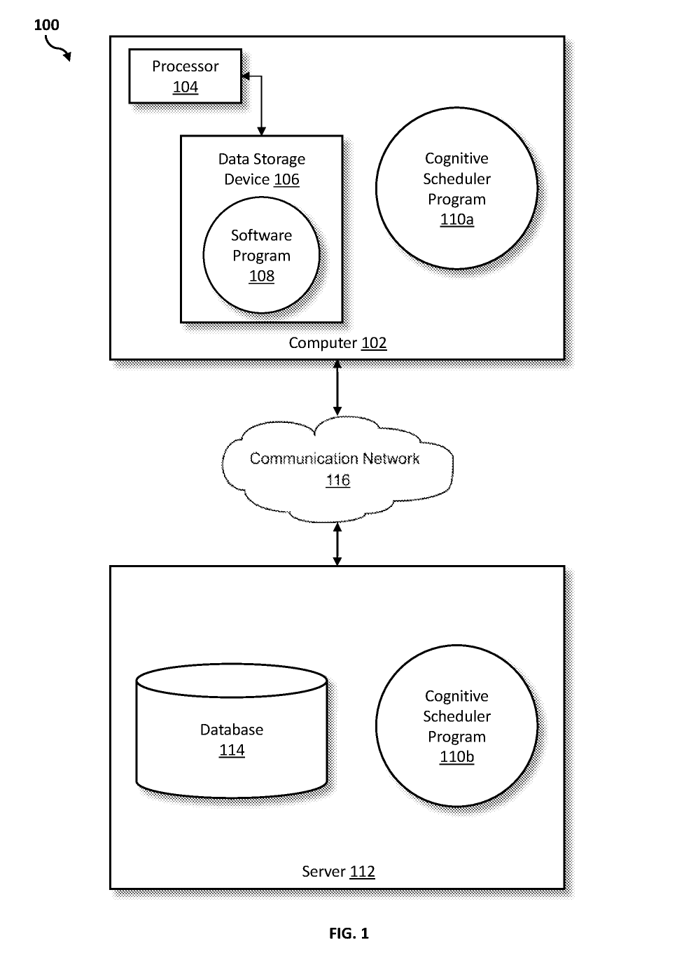

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a cognitive scheduler program 110a. The networked computer environment 100 may also include a server 112 that is enabled to run a cognitive scheduler program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

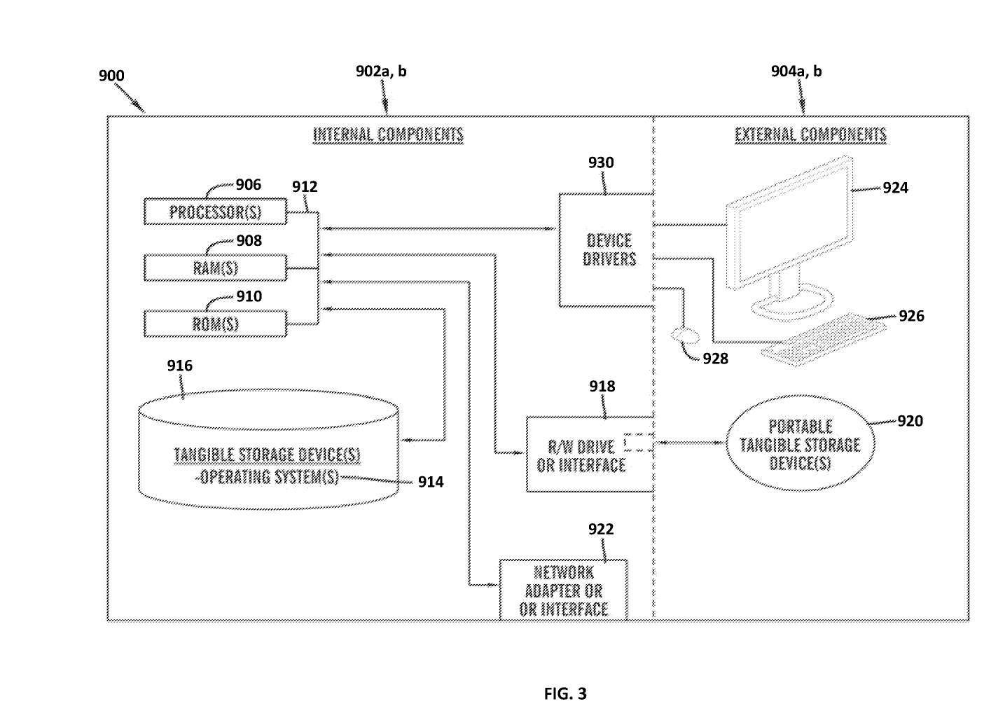

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the cognitive scheduler program 110a, 110b may interact with a database 114 that may be embedded in various storage devices, such as, but not limited to a computer/mobile device 102, a networked server 112, or a cloud storage service.

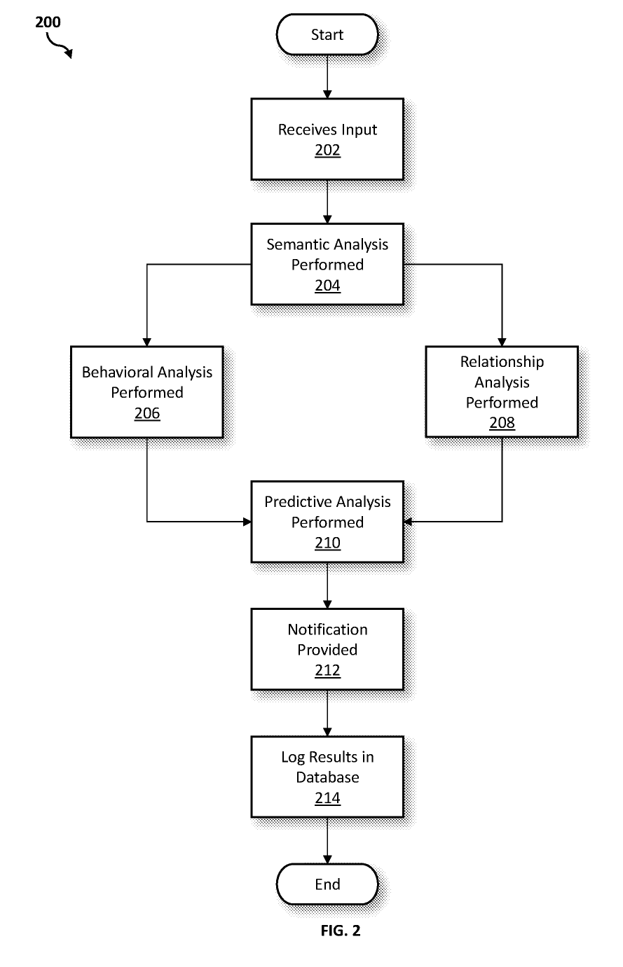

According to the present embodiment, a user using a client computer 102 or a server computer 112 may use the cognitive scheduler program 110a, 110b (respectively) to organize events to maximize productivity. The cognitive scheduling method is explained in more detail below with respect to FIG. 2.

Referring now to FIG. 2, an operational flowchart illustrating the exemplary cognitive scheduling process 200 used by the cognitive scheduler program 110a, 110b according to at least one embodiment is depicted.

At 202, the cognitive scheduler program 110a, 110b receives an input. Data received from a calendar or schedule application, social media, emails and text messages may be some examples of input sources. An input may be manually entered by the user and may originate from different software applications. Manual entry examples may include a user inputting via a keyboard a meeting event and time into a calendar application or a task application. A verbal input may also be entered into software applications through a device microphone. Another input may be created and entered by the cognitive scheduler program 110a, 110b which may alter, add, or delete an event and notify the user of possible changes in the user's schedule that may increase the user's productivity. Both user input and input from other individuals may be captured for analysis by the cognitive scheduler program 110a, 110b. An example of input from another individual may include data the individual posted or responded to on social media, an email or a text message.

Next at 204, the cognitive scheduler program 110a, 110b performs semantic analysis on the received input. Semantic analysis may consider a user's currently scheduled activities, historical activities, communications, other individuals involved in the activities, topics discussed and frequency of the activities and discussion topics. Semantic analysis may analyze syntactic structures at many levels to infer meaning from the user's phrases, sentences and paragraphs. Static data may be analyzed through semantic analysis when the cognitive scheduler program 110a, 110b receives raw data from different software applications and filters the data into meaningful data for analysis.

Semantic analysis may also sort and identify data for analysis. For example, the semantic analysis module may identify, from the various sources of input data, information relating to the user's relationship with other individuals. Relationship data may be filtered and sent from the semantic analysis module to the relationship analysis module for analysis. The data that may be sent to the relationship analysis module may include historical communications between the user and another individual, or the user and multiple other individuals. Historical communications that may be sorted and sent to the relationship analysis module may include, for example, chats, emails, phone calls and social media accounts. The topics discussed and the frequency of interactions between the user and another individual or individuals may also be sorted and sent to the relationship module for analysis.

The semantic analysis module may also identify, from various sources of input data, information relating to the user's behavior. Behavioral data may also be filtered and sent from the semantic analysis module to the behavior analysis module. The data that may be sent to the behavioral analysis module may include user biometric data, user sentiment and the user's emotional state. Behavioral data for other individuals may also be identified and sent from the semantic analysis module to the behavior analysis module. Further data sent to the behavior analysis module may include user routines, scheduled activities and unscheduled activities (e.g., getting a coffee or lunch).

Then at 206, the cognitive scheduler program 110a, 110b performs behavioral analysis. Behavior analysis may consider behavior and biometric patterns of the user as well as user sentiment. Biometric patterns may provide data regarding the user's heart rate, body temperature, blood flow and other physical characteristics of the user. Sentiment data may be received by the cognitive scheduler program 110a, 110b as data that may show the user's emotional responses. Sentiment data may be a user's facial expressions, vocal inflections and written expressions posted to the user's social media accounts, emails or text messages.

Behavior analysis may also consider user routines, scheduled activities and unscheduled activities in the context of the user's emotional state. The cognitive scheduler program 110a, 110b may analyze behavioral patterns in context of a user's daily activities and sub-tasks that the user may be involved with that are not part of the user's daily schedule. Then the cognitive scheduler program 110a, 110b may identify user dependencies and time constraints to further identify which activities may interfere with the user's scheduled activity. Once the user's routine is observed, the cognitive scheduler program 110a, 110b may analyze the user's current emotional state as it might have an impact on unscheduled activities.

Next at 208, the cognitive scheduler program 110a, 110b performs a relationship analysis. Relationship analysis may consider the relationship between the user and the other people involved in the activities. Regression behavioral pattern analysis and semantic analysis may be performed on the user and the individuals associated with historic activities. Regression behavioral analysis may use mathematical equations for predictions using different variables (i.e., different people). By analyzing the behavioral patterns and semantic patterns, the cognitive scheduler program 110a, 110b may infer the relationships by analyzing historical interactions. Historical communications analysis may include chats, emails, phone calls, topics discussed in the interactions, frequency of interactions and social media.

Another feature of the cognitive scheduler program 110a, 110b may determine which other people are involved in the scheduled activity and analyze schedule variations based on comparing the user's actual activities with the user's planned activities. The cognitive scheduler program 110a, 110b may then update the user's schedule accordingly based on analyzing how a user's schedule may be affected.

Then at 210, the cognitive scheduler program 110a, 110b performs predictive analysis. The predictive analysis module may collect data, in a database 114, and analyze the user's historical and current activities. The predictive analysis module may also infer and suggest minimally disruptive, precursory or parallel activities, or precursory and parallel activities that may help the user stay on track with all other scheduled activities. Minimally disruptive proposed activities may include eating lunch, standing up to stretch, going for a walk or getting a cup of coffee. Additionally, extra activities proposed may calculate potential scheduling conflicts when another individual schedules an activity involving the user being analyzed.

Minimally disruptive activities may apply to the user and may also apply to other individuals involved in an event. Predictive analysis may combine analyses performed (e.g., semantic analysis, behavioral analysis and relationship analysis) to discern a good solution for a user's schedule. While discerning a good solution, the cognitive scheduler program 110a, 110b may analyze both the user's schedule and other individuals schedules to find a mutually beneficial time to adjust a schedule. A mutually beneficial time may create a more productive environment for the user since the other individuals involved may be more alert at a certain time as opposed to a time when they may not be as alert. For example, if a user is consistently running late for a meeting with another individual, then the predictive analysis module may find a mutually beneficial time for the meeting for maximum productivity for both parties involved, ultimately benefiting the user.

The predictive analysis module may predict solutions for one analysis module or for more than one analysis module between semantic analysis, behavioral analysis and relationship analysis. The predictive analysis module may also predict solutions for a single user, multiple users and for a user that may interact with other individuals. Other individuals may be an event coordinator or another person attending an event or meeting. Analysis, for example, of scheduled activities, unscheduled activities, routines, user's behavior, user's emotional state and impact of activities may be considered by the cognitive scheduler program 110a, 110b. Based on the cognitive scheduler program 110a, 110b analysis, new or altered events may be proposed via a notification to the user to maximize productivity while minimizing the impact on the scheduled events.

Next at 212, the cognitive scheduler program 110a, 110b provides notification. The cognitive scheduler program 110a, 110b may also use alternative means to notify the user based on current activities. A notification may be, for example, from a phone alert, a voice command, an email, or a text message. The notification may ask the user if the altered schedule entry may be accepted by the user. The notification may also provide an explanation of why the cognitive scheduler program 110a, 110b may be changing the user's schedule. For example, the user may have a habit of staying late after a specific meeting and then schedule another event to begin at the same time and day that the previous event ends. If the user has a particular meeting scheduled every Monday from 11:00 a.m.-12:00 p.m. and the user adds a new event to begin on Monday at 12:00 p.m., then the cognitive scheduler program 110a, 110b may alert the user not to schedule the new event for 12:00 p.m., and rather suggest that the new meeting begin at 12:30 p.m. The cognitive scheduler program 110a, 110b may also offer an extra notification to alert the user as to why the new Monday meeting should begin at 12:30 p.m., which is due to the user typically not leaving the already scheduled Monday meeting until 12:15 p.m. Another feature of the cognitive scheduler program 110a, 110b may include alerting the user to extend the weekly Monday meeting time to be 11:00 a.m.-12:15 p.m. and alert the other attendees if the user wishes to change the meeting time.

The notification module may be responsible for communicating to the user and updating the user's schedule as needed based on the input provided by the predictive analysis module to the notification module. Notifications may include a verbal message, a text message, an alert, an alarm, an email, or a notification pop-up on a screen. The verbal message may originate from speakers on any device such as a computer 102, a cellular phone, a tablet, a watch or a vehicle. A written message may be received by the user on any device capable of receiving a written text message such as a computer 102, a cellular phone, a tablet, a watch or a vehicle.

Then at 214, the cognitive scheduler program 110a, 110b logs the results into a database 114. The database 114 may collect analysis, predictions and alerts. The database 114 may save decisions the user made from alerts offered by the cognitive scheduler program 110a, 110b in order to create a user history of preferences. As the database collects user preferences, the cognitive scheduler program 110a, 110b may become more robust and may be able to better predict a user's preferences based on the user's habits. The database 114 may also collect data from other individuals involved in the current user's schedule. More data collected may create a more robust cognitive system that may predict better results for a user.

One example for the use of the cognitive scheduler program 110a, 110b may be in the case of a user (i.e., attendee) who always misses a specific meeting. The cognitive scheduler program 110a, 110b may analyze precursory events for that attendee and determine, classify and categorize the reason the attendee misses the scheduled activity. Based on the classification and categorization determined, the cognitive scheduler program 110a, 110b may recommend the attendee re-schedule or re-prioritize precursory activities to the scheduled event. The cognitive scheduler program 110a, 110b may also recommend the event coordinator look for an alternative day or time for the scheduled event.

Another example of the cognitive scheduler program 110a, 110b may be in the case of a user whose schedule is too tight for the user's normal lunch time of 45 minutes. Instead of the 45 minute lunch time, the user now may have a shortened time window of 30 minutes for lunch. The cognitive scheduler program 110a, 110b may break the task of lunch into two sub-tasks where both are done within 30 minutes. The two sub-tasks are based on the shortened time window and although the sub-tasks are an effort to get the user to make time for a shortened lunch, the tasks are otherwise independent tasks such as warming up food and eating time. In this scenario, the user's meeting ended early at 11:30 a.m., the user has a scheduled client call from 11:45 a.m.-12:00 p.m. and another meeting scheduled for 12:30 p.m.-1:30 p.m. The cognitive scheduler program 110a, 110b may analyze and extrapolate the user's habit of a 45 minute lunch window and the result of the scheduled events would mean the user misses lunch completely or the user is late for the 12:30 p.m. meeting. The cognitive scheduler program 110a, 110b may then analyze the user's emotional state by analyzing user chats, emails and social media accounts and recommend different outcomes based on the user's current emotional state.

If the current emotional state of the user is calm, the cognitive scheduler program 110a, 110b may send a notification to the user at 11:30 a.m., suggesting the user begin warming up their lunch (i.e., the first time dependent sub-task). Then, once the user completes the client call at 12:00 p.m., the cognitive scheduler program 110a, 110b may notify the user to eat lunch (i.e., second time dependent sub-task) before the next upcoming meeting. Alternatively, if the current emotional state of the user is upset, then the cognitive scheduler program 110a, 110b may send the user a notification at 11:30 a.m. to take a 5 minute walk. Then at 11:35 a.m., the user may be alerted to begin warming up their lunch (i.e., first time dependent sub-task). Once the user finishes the client phone call at 12:00 p.m., the user is reminded to eat lunch (i.e., second time dependent sub-task) before the next upcoming meeting.

As previously stated, the cognitive scheduler program 110a, 110b may use semantic analysis, behavioral analysis and relationship analysis in any order. The cognitive scheduler program 110a, 110b may also use one or more of the semantic analysis module, behavioral analysis module and relationship analysis module to predict and possibly add, delete or alter a user's schedule. Each module (e.g., semantic analysis module, behavioral analysis module and relationship analysis module) may work independently, interdependently or dynamically with one another.

It may be appreciated that FIG. 2 provides only an illustration of one embodiment and does not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 3. Each of the sets of internal components 902 a, b includes one or more processors 906, one or more computer-readable RAMs 908, and one or more computer-readable ROMs 910 on one or more buses 912, and one or more operating systems 914 and one or more computer-readable tangible storage devices 916. The one or more operating systems 914, the software program 108 and the cognitive scheduler program 110a in client computer 102, and the cognitive scheduler program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the cognitive scheduler program 110a, 110b can be stored on one or more of the respective portable computer-readable tangible storage devices 920, read via the respective R/W drive or interface 918, and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the cognitive scheduler program 110a in client computer 102 and the cognitive scheduler program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the cognitive scheduler program 110a in client computer 102 and the cognitive scheduler program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926, and computer mouse 928. The device drivers 930, R/W drive or interface 918, and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

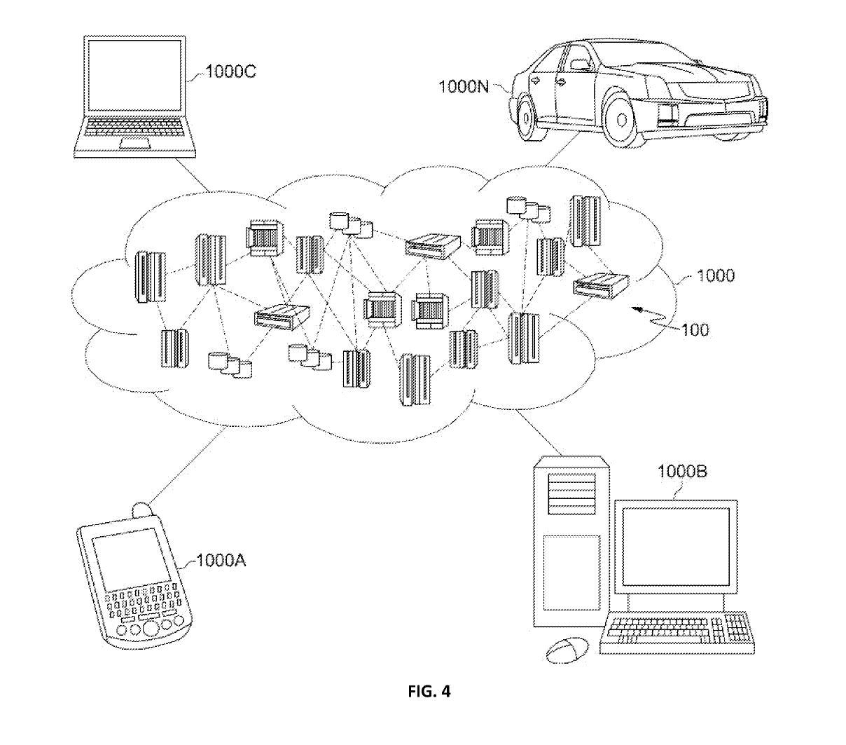

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

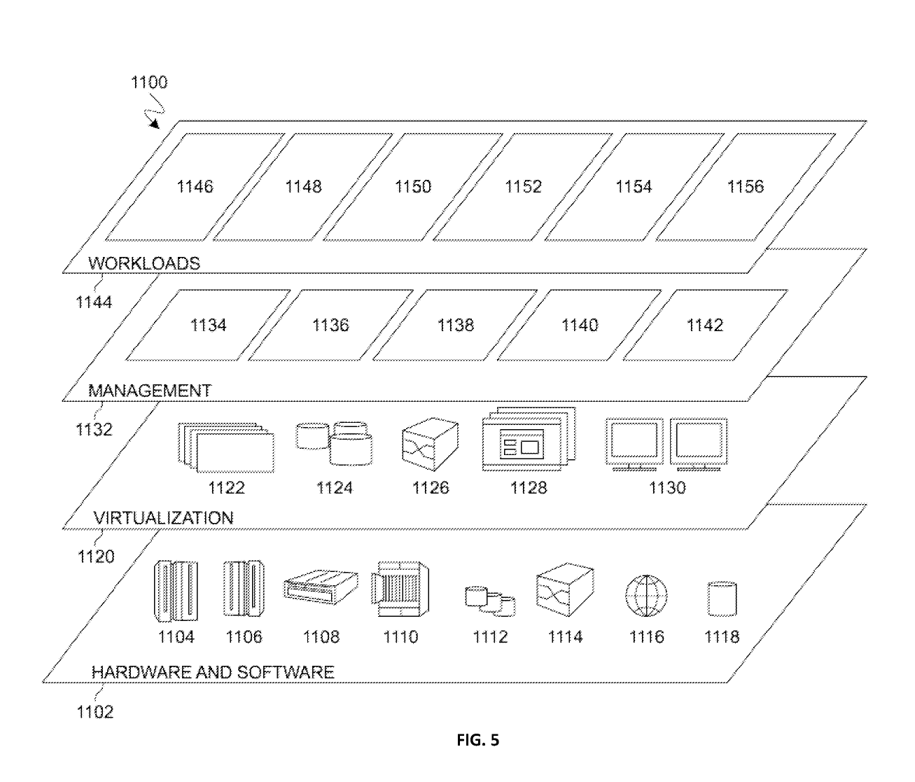

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and cognitive scheduling 1156. A cognitive scheduler program 110a, 110b provides a way to dynamically organize events.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for cognitive scheduling, the method comprising:
receiving an input;
performing a semantic analysis based on the received input;
performing further analysis based on the performed semantic analysis;
performing a predictive analysis based on the performed semantic analysis and the performed further analysis; and
providing a notification to a user based on the performed predictive analysis.

2. The method of claim 1, wherein further analysis further comprises:
performing a behavioral analysis based on the performed semantic analysis; and
performing a relationship analysis based on the performed semantic analysis,
wherein performing the predictive analysis is based on the performed semantic analysis, behavioral analysis and relationship analysis.

3. The method of claim 1, wherein further analysis further comprises:
performing a relationship analysis based on the performed semantic analysis; and
performing a behavioral analysis based on the performed semantic analysis,
wherein performing the predictive analysis is based on the performed semantic analysis, behavioral analysis and relationship analysis.

4. The method of claim 1, wherein the semantic analysis is performed in a semantic analysis module, wherein the semantic analysis module identifies data, and wherein the identified data is sorted and sent to a behavioral analysis module and a relationship analysis module.

5. The method of claim 1, wherein the predictive analysis is performed in a predictive analysis module, wherein the predictive analysis module collects data, wherein the collected data is data received from a behavior analysis module and a relationship analysis module, and wherein the collected data is used to analyze a plurality of historical activities associated with the user and a plurality of current activities associated with the user.

6. The method of claim 2, wherein the behavioral analysis is performed in a behavioral analysis module, wherein the behavioral analysis module receives data from a semantic analysis module, and wherein the received data is selected from the group consisting of at least one user behavior, at least one user biometric response and at least one user sentiment.

7. The method of claim 2, wherein the relationship analysis is performed in a relationship analysis module, wherein the relationship analysis module receives data from the semantic analysis module, and wherein the received data is used to analyze a relationship between the user and other individuals involved in a plurality of scheduled activities and in a plurality of unscheduled activities.

8. A computer system for cognitive scheduling, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving an input;
performing a semantic analysis based on the received input;
performing further analysis based on the performed semantic analysis;
performing a predictive analysis based on the performed semantic analysis and the performed further analysis; and
providing a notification to a user based on the performed predictive analysis.

9. The computer system of claim 8, wherein further analysis further comprises:
performing a behavioral analysis based on the performed semantic analysis; and
performing a relationship analysis based on the performed semantic analysis,
wherein performing the predictive analysis is based on the performed semantic analysis, behavioral analysis and relationship analysis.

10. The computer system of claim 8, wherein further analysis further comprises:
performing a relationship analysis based on the performed semantic analysis; and
performing a behavioral analysis based on the performed semantic analysis,
wherein performing the predictive analysis is based on the performed semantic analysis, behavioral analysis and relationship analysis.

11. The computer system of claim 8, wherein the semantic analysis is performed in a semantic analysis module, wherein the semantic analysis module identifies data, and wherein the identified data is sorted and sent to a behavioral analysis module and a relationship analysis module.

12. The computer system of claim 8, wherein the predictive analysis is performed in a predictive analysis module, wherein the predictive analysis module collects data, wherein the collected data is data received from a behavior analysis module and a relationship analysis module, and wherein the collected data is used to analyze a plurality of historical activities associated with the user and a plurality of current activities associated with the user.

13. The computer system of claim 9, wherein the behavioral analysis is performed in a behavioral analysis module, wherein the behavioral analysis module receives data from a semantic analysis module, and wherein the received data is selected from the group consisting of at least one user behavior, at least one user biometric response and at least one user sentiment.

14. The computer system of claim 9, wherein the relationship analysis is performed in a relationship analysis module, wherein the relationship analysis module receives data from the semantic analysis module, and wherein the received data is used to analyze a relationship between the user and other individuals involved in a plurality of scheduled activities and in a plurality of unscheduled activities.

15. A computer program product for cognitive scheduling, comprising:
one or more computer-readable storage medium and program instructions stored on at least one of the one or more tangible storage medium, the program instructions executable by a processor, the program instructions comprising:
program instructions to receive an input;
program instructions to perform a semantic analysis based on the received input;
program instructions to perform further analysis based on the performed semantic analysis;
program instructions to perform a predictive analysis based on the performed semantic analysis and the performed further analysis; and
program instructions to provide a notification to a user based on the performed predictive analysis.

16. The computer program product of claim 15, wherein further analysis further comprises:
program instructions to perform a behavioral analysis based on the performed semantic analysis; and
program instructions to perform a relationship analysis based on the performed semantic analysis,
wherein performing the predictive analysis is based on the performed semantic analysis, behavioral analysis and relationship analysis.

17. The computer program product of claim 15, wherein further analysis further comprises:
program instructions to perform a relationship analysis based on the performed semantic analysis; and
program instructions to perform a behavioral analysis based on the performed semantic analysis,
wherein performing the predictive analysis is based on the performed semantic analysis, behavioral analysis and relationship analysis.

18. The computer program product of claim 15, wherein the semantic analysis is performed in a semantic analysis module, wherein the semantic analysis module identifies data, and wherein the identified data is sorted and sent to a behavioral analysis module and a relationship analysis module.

19. The computer program product of claim 15, wherein the predictive analysis is performed in a predictive analysis module, wherein the predictive analysis module collects data, wherein the collected data is data received from a behavior analysis module and a relationship analysis module, and wherein the collected data is used to analyze a plurality of historical activities associated with the user and a plurality of current activities associated with the user.

20. The computer program product of claim 16, wherein the behavioral analysis is performed in a behavioral analysis module, wherein the behavioral analysis module receives data from a semantic analysis module, and wherein the received data is selected from the group consisting of at least one user behavior, at least one user biometric response and at least one user sentiment.
